(19) United States
(12) Patent Application Publication
(10) Pub. No.: US 2026/0287149 A1
(43) Pub. Date: Sep. 24, 2026

(54) ADJUSTABLE LIGHTING SYSTEM

(71) Applicant: DELTA INTELLIGENT BUILDING TECHNOLOGIES (USA), LLC, Oakland, NJ (US)

(72) Inventors: Avinash SANICHAR, Bloomfield, NJ (US); Ernesto M. BUCHANA, Clifton, NJ (US); Alister MALLET, Bushkill, PA (US)

(73) Assignee: DELTA INTELLIGENT BUILDING TECHNOLOGIES (USA), LLC, Oakland, NJ (US)

(21) Appl. No.: 19/684,078

(22) Filed: May 21, 2026

Related U.S. Application Data
(63) Continuation-in-part of application No. 18/753,411, filed on Jun. 25, 2024, now abandoned.

(51) Int. Cl. F21V 7/00; F21V 21/14; F21Y 103/10

(52) U.S. Cl. CPC F21V 7/005; F21V 21/14; F21Y 2103/10

(57) ABSTRACT

A lighting system includes first and second housing portions movable between retracted and extended configurations. A first direct reflector is positioned within the first housing portion, and a second direct reflector is positioned within the second housing portion. An expandable LED board includes a rigid portion fixed relative to the second housing portion and configured to span an adjustment gap, and an expandable portion disposed within the first housing portion. The rigid portion is slidably received within a slot of the first direct reflector during adjustment, while an end of the expandable portion opposite the rigid portion is held relative to the first housing portion so movement between the housing portions causes the expandable portion to lengthen or shorten. Conductive ribbons electrically interconnect board segments of the expandable portion to maintain electrical continuity.

### CROSS-REFERENCE TO RELATED APPLICATIONS

The present application claims the benefit as a continuation-in-part of U.S. patent application Ser. No. 18/753,411, filed Jun. 25, 2024, and entitled “TELESCOPING LIGHTING SYSTEM,” the entire contents of which are incorporated herein by reference.

### FIELD OF THE DISCLOSURE

The subject disclosure relates to lighting systems, and more particularly, to length adjustable linear lighting systems.

### BACKGROUND

Lighting systems have long been utilized to offer efficient illumination across diverse settings and applications. Among these systems, linear lighting solutions have gained significant popularity due to their versatility and ease of installation. Such systems typically involve the arrangement of prefabricated LED boards within a housing, emitting light through an output lens in a linear fashion.

However, a notable drawback of conventional linear lighting systems lies in their lack of adjustability in length. These systems typically rely on fixed configurations of LED boards, limiting the flexibility to customize lighting solutions according to specific needs and dimensions. In such setups, achieving varying light source lengths often necessitates either combining different numbers of prefabricated boards or utilizing boards of different lengths, which may not always align with the precise requirements of custom applications. Indeed designing lighting solutions for bespoke applications becomes challenging when restricted to the available sizes and types of prefabricated boards accessible in the market.

To address these drawbacks and enhance the versatility of linear lighting solutions, there is a need for innovations that enable adjustable length functionality without compromising efficiency or performance.

### SUMMARY

In accordance with the subject technology, embodiments of the disclosure include a lighting system. The lighting system has a first housing portion and a second housing portion configured for relative movement with respect to one another along a longitudinal axis of the lighting system. The first housing portion and the second housing portion may be positioned in abutting relationship in a retracted configuration at a minimum configured length, and may be longitudinally separated in an extended configuration to define an adjustment gap between opposing ends of the first and second housing portions. A first direct reflector may be positioned within the first housing portion, and a second direct reflector may be positioned within the second housing portion. The first and second housing portions, the first and second direct reflectors, and, in some embodiments, the optical control vanes may collectively define an optical cavity extending along the lighting system.

In other embodiments, the lighting system may include an expandable LED board comprising a rigid portion and an expandable portion. The rigid portion may be fixed relative to the second housing portion and configured to span the adjustment gap. The expandable portion may be disposed within the first housing portion and configured to lengthen or shorten in response to displacement of the first housing portion relative to the rigid portion. The expandable LED board may be fixed relative to the lighting system at first and second longitudinally spaced anchoring locations. At the first anchoring location, the rigid portion may be secured relative to the second housing portion, such as within a slot of the second direct reflector. At the second anchoring location, an end of the expandable portion opposite the rigid portion may be secured relative to the first housing portion, such as within a slot of the first direct reflector. Between the first and second anchoring locations, at least part of the expandable LED board may be slidably received within one or both of the slots so that relative movement between the first and second housing portions is accommodated by longitudinal expansion or collapse of the expandable portion. The rigid portion may extend longitudinally from the second housing portion into the slot of the first direct reflector and may remain slidably received therein during adjustment. The rigid portion may be additionally securable within the slot of the first direct reflector after adjustment to fix the first and second housing portions at a selected configured length.

In other embodiments, the expandable portion may include a plurality of board segments arranged in longitudinal series within the first housing portion. A plurality of LED packages may be disposed on downward-facing surfaces of the board segments. Adjacent board segments may be electrically interconnected by conductive ribbons configured to maintain electrical continuity as the expandable portion lengthens or shortens. Each board segment may be individually secured to a corresponding plate segment by one or more fasteners received through mounting apertures defined through the board segment, joining each board-segment-and-plate-segment pair in a face-to-face stacked relationship with the LED packages facing downwardly away from the corresponding plate segment.

In other embodiments, the plate segments may form a longitudinally expandable and retractable structural backbone underlying the board segments. Each plate segment may define a planar body portion, an extension tongue projecting longitudinally from a first longitudinal end of the planar body portion, and first and second arms extending longitudinally from an opposing second longitudinal end of the planar body portion. The first and second arms may be spaced laterally apart to define a receiving channel therebetween sized to slidably receive the extension tongue of an adjacent plate segment. The extension tongue may include a retaining shoulder, and inward-facing surfaces of the first and second arms may define stop surfaces configured to engage the retaining shoulder to arrest further separation between adjacent plate segments and retain the adjacent plate segments in interlocked engagement without disassembly.

In other embodiments, the first direct reflector may define a first slot opening downwardly into the optical cavity, and the second direct reflector may define a second slot opening downwardly into the optical cavity. The first and second slots may extend along substantially the full longitudinal lengths of the first and second direct reflectors, respectively. The expandable portion may be received within the first slot of the first direct reflector, and the rigid portion may be received within and secured to the second slot of the second direct reflector. The first slot may slidably receive part of the rigid portion in a gap-facing region of the first slot and may receive the expandable portion in a longitudinally spaced region of the first slot. In some embodiments, the first and second slots may be dimensioned to receive a combined plate-segment-and-board-segment stack as a unit, with the LED packages oriented to face downwardly out of the first and second slots and into the optical cavity.

In other embodiments, the lighting system may include a bracket secured to the second housing portion and first and second optical control vanes carried by the bracket. The optical control vanes may project into the adjustment gap to provide optical control of light emitted downwardly from LED packages of the rigid portion in an exposed region between the first and second housing portions. The optical control vanes may be stationary relative to the second housing portion and may provide optical control in the adjustment gap while the direct reflectors govern optical output within the portions of the optical cavity disposed in the first and second housing portions.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1A shows a top perspective view of a lighting system in a retracted configuration in accordance with the subject technology.

FIG. 1B shows a top perspective view of the lighting system of FIG. 1A in an extended configuration in accordance with the subject technology.

FIG. 2 shows an exploded perspective view of the lighting system of FIGS. 1A-1B in accordance with the subject technology.

FIG. 3 shows a cross-sectional plan view of the lighting system of FIGS. 1A-2 in accordance with the subject technology.

FIG. 4 shows isolated, cross-sectional plan views of a housing and the installation of housing trims thereto, associated with the lighting system of FIGS. 1A-3 in accordance with the subject technology.

FIG. 5A shows a subjacent perspective view of the lighting system of FIG. 1A also in a retracted configuration in accordance with the subject technology.

FIG. 5B shows a subjacent perspective view of the lighting system of FIG. 1A also in an extended configuration in accordance with the subject technology.

FIG. 6A shows a side plan view of the lighting system of FIG. 1A also in a retracted configuration in accordance with the subject technology.

FIG. 6B shows a side plan view of the lighting system of FIG. 1B also in an extended configuration in accordance with the subject technology.

FIG. 7A shows a top perspective view of a lighting system in a retracted configuration in accordance with a further embodiment of the subject technology.

FIG. 7B shows a top perspective view of the lighting system of FIG. 7A in an extended configuration in accordance with the subject technology.

FIG. 8 shows an exploded perspective view of the lighting system of FIGS. 7A-7B in accordance with the subject technology.

FIG. 9 shows a cross-sectional plan view of the lighting system of FIGS. 7A-8 in accordance with the subject technology.

FIG. 10 shows a perspective view of an expandable LED board of the lighting system of FIGS. 7A-9 in accordance with the subject technology.

FIG. 11 shows an enlarged detail view of the expandable LED board of FIG. 10 in accordance with the subject technology.

FIG. 12A shows a subjacent perspective view of the lighting system of FIG. 7A also in a retracted configuration in accordance with the subject technology.

FIG. 12B shows a subjacent perspective view of the lighting system of FIG. 7A also in an extended configuration in accordance with the subject technology.

FIG. 13A shows a side plan view of the lighting system of FIG. 7A also in a retracted configuration in accordance with the subject technology.

FIG. 13B shows a side plan view of the lighting system of FIG. 7B also in an extended configuration in accordance with the subject technology.

### DETAILED DESCRIPTION

The subject technology overcomes many of the prior art problems associated with lighting systems. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

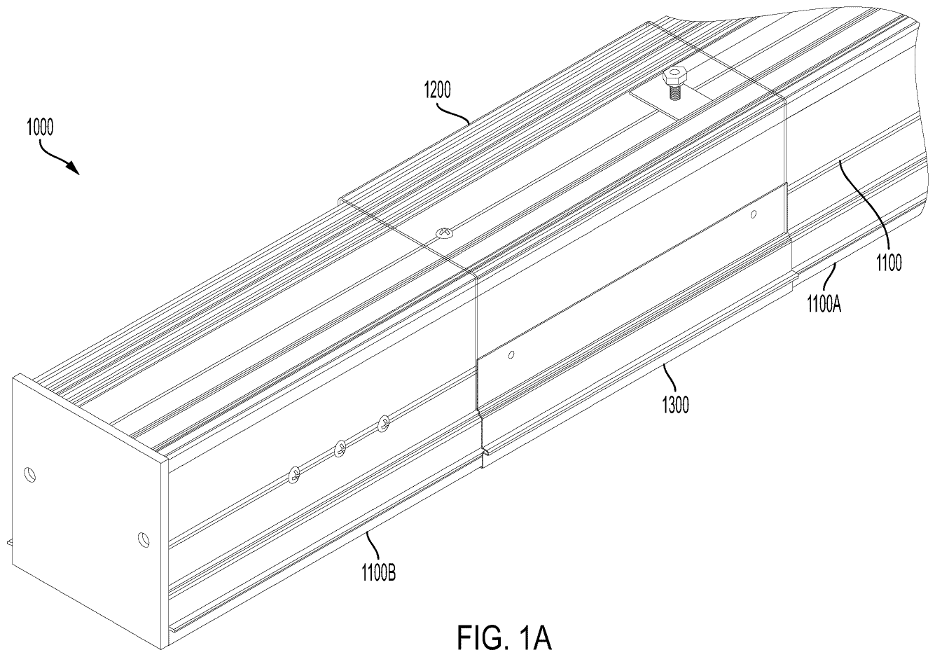

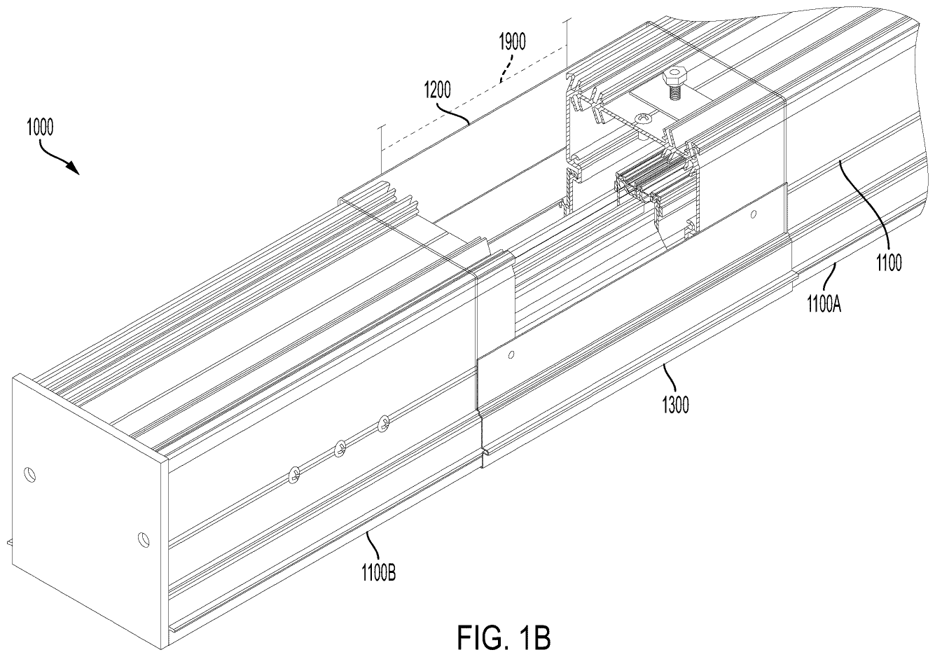

Referring now to FIGS. 1A and 1B, perspective views of a linear lighting system 1000 are shown. This luminaire 1000 uses elongated optics to distribute light over a more narrow area compared to traditional lighting. Usually, the linear lighting system 1000 is installed suspended from a ceiling, surface mounted to a wall or ceiling, or recessed into a wall or ceiling. Features, advantages, and principles taught by the description of linear lighting system 1000 can also be used in alternative types of lighting systems and systems such as, for example, recessed lighting, track lighting and monorail, chandeliers, pendants, sconces, ceiling lights, floor and table lamps, and outdoor lighting.

Notably, the linear lighting system 1000 is extendable, in that the system 1000 can extend and retract based on a desired length during installation. It is often expensive for a manufacturer to create, and a wholesaler to shelf, various sized lighting systems, and further, for a contractor to adjust the length of a desired lighting system during installation. Thus, the inventors of the subject application derived a unique solution thereto, described in full detail below.

The linear lighting system 1000 includes a housing 1100. The housing 1100 has a linear shape, extending, for example, along a depth dimension from the bottom left to the upper right side of FIGS. 1A and 1B. Further, the housing 1100 is composed of shrouded aluminum, though, the size, material, and overall design of the housing 1100 can be varied based on concept or application.

The housing 1100 is split into two distinct portions, referred to herein as a first housing portion 1100A and a second housing portion 1100B. However, it's worth noting that the housing 1100 can come in several different configurations, including more than two housing portions. That is, concepts described herein range over several different housing arrangements and structures and should not be limited in nature to the embodiments discussed herein.

FIG. 1A shows the first and second housing portions 1100A, 1100B visibly integral, with a housing cover 1200 and light shield 1300 joining the two. However, in FIG. 1B, the first and second housing portions 1100A, 1100B are distanced from each other, separated by an adjustment gap 1900, though still connected by the housing cover 1200 and light shield 1300.

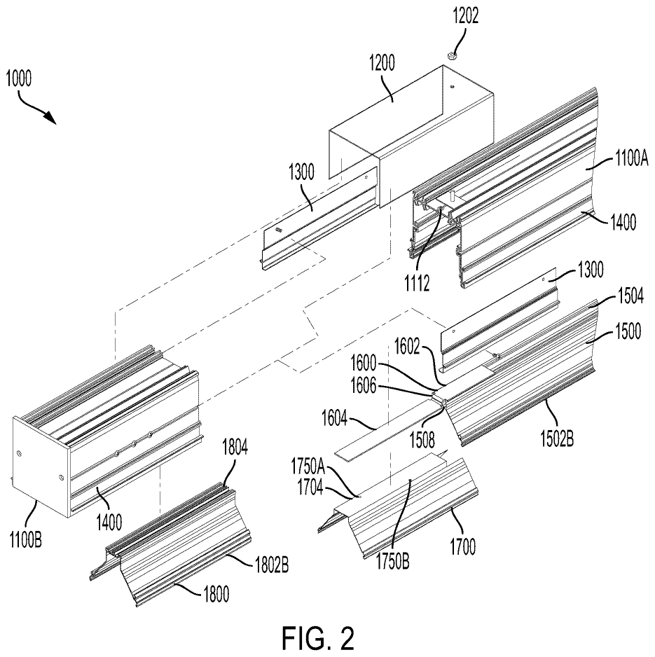

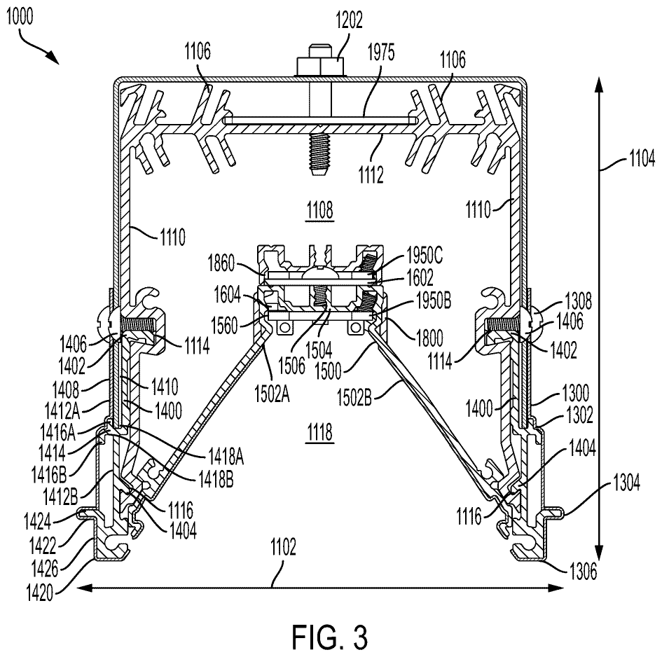

Referring now to FIGS. 2 and 3, exploded and cross-sectional views of the lighting system 1000 are shown. As mentioned with reference to the description prior, each housing portion 1100A, 1100B has a linear shape, extending, for example, along a depth dimension extending into or out of the page of FIG. 3. The housing portions 1100A, 1100B are rectangular shaped, prolonging in a horizontal dimension 1102 by roughly 2.0 inches, and a vertical dimension 1104 by roughly 3.5 inches. Further, the housing portions 1100A, 1100B are composed of shrouded aluminum, though, the size, material, and overall design of each portion 1100A, 1100B can be varied based on concept or application. Each portion 1100A, 1100B defines several screw bosses 1106 to aid in the assembly of mounting parts by providing channels for screws (not distinctly shown).

Collectively, the housing portions 1100A, 1100B define a housing cavity 1108 due to the flat-bottomed, U-shape configuration of the housing portions 1100A, 1100B, formed by sidewalls 1110 and an intersecting crossbar 1112 extending between the sidewalls 1110. The housing cavity 1108 provides a lighting environment for reflection and projection of light rays in a desired format and direction.

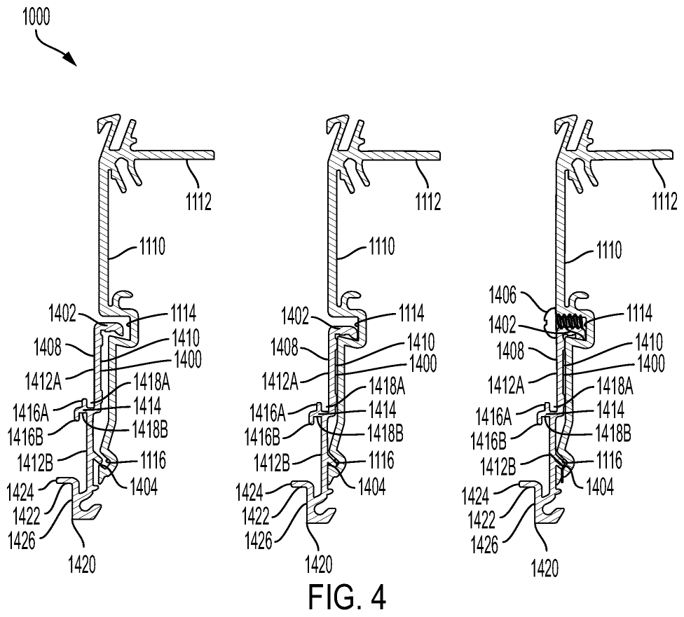

Referring additionally to FIG. 4, the sidewalls 1110 of the housing portions 1100A, 1100B, define an inward alcove 1114. The sidewalls 1110 of each housing portion 1100A, 1100B also each define a trim inlet 1116. The trim inlet 1116 and the inward alcove 1114 each serve as receiving terminals for joining with a housing trim 1400. As such, each of the inward alcove 1114 and trim inlet 1116 functions to interface with a housing trim 1400. For example, as best shown in FIGS. 3 and 4, the inward alcove 1114 depicted serves as a screw boss for attachment and lodging of a housing trim 1400 therein.

Various deployments of the housing trim 1400 can be realized for association with the housing portions 1100A, 1100B as best described in U.S. patent application Ser. No. 18/416,185, entitled REFLECTOR AND REFLECTOR HOUSING FOR A LINEAR LIGHTING SYSTEM and filed on Jan. 18, 2024, the entirety of which is incorporated herein by reference for any purpose whatsoever. In general, the housing trim 1400 is complimentary to the housing 1100, embodying a similar relative silhouette to the sidewalls 1110 and extending into the page of FIGS. 3 and 4. Each housing trim 1400 contemplated herein varies in size, shape, and functionality, and in turn, several further embodiments of the housing trim 1400 may be contemplated by the subject technology although not specifically enumerated herein.

Turning to the structure of the housing trim 1400, FIG. 4 exemplifies a housing trim 1400 with a linking claw 1402 for insertion into the inward alcove 1114, and an intermediate rib 1404 for insertion into the trim inlet 1116 of the housing 1100. A screw 1406 is driven into the inward alcove 1114 between the housing portion 1100A, 1100B and linking claw 1402, sandwiching the linking claw 1402 against the inward alcove 1114. By nature of the angled architecture of the intermediate rib 1404 defined by the housing trim 1400, it too is pressured into the trim inlet 1116, thus ensuring snug contact with the housing 1100.

The external surface 1408 of the housing trim 1400, opposite the internal surface 1410 abutting the housing 1100, defines a shape serving as a rail guide. In particular, and still referring to FIG. 4, the external surface 1408 of the housing trim 1400 begins at the linking claw 1402 and generally runs vertically, as defined in FIG. 3, between a first and second portion 1412A, 1412B, with an intermediate junction 1414 bisecting the sections. The intermediate junction 1414 defines an upward and downward standing ledge 1416A, 1416B, laterally offset from one another. Each ledge 1416A, 1416B, by nature of their projecting structure, forms a first and second linkage nexus 1418A, 1418B. Towards a foot 1420 of the housing trim 1400, opposite vertically of the linking claw 1402, the external surface 1408 of the housing trim 1400 defines an elbow 1422 with a lateral projection 1424 and a vertical projection 1426 that integrate with the foot 1420.

Referring back to FIG. 3, the light shield 1300 complements the external surface 1408 of the housing trim 1400 in shape for cooperation therewith. Specifically, the light shield 1300 defines a ridge 1302 which rests on the curved nature of the intermediate junction 1414 of the housing trim 1400. Further, the light shield 1300 defines a trench 1304 which wraps around and receives the lateral projection 1424 of the elbow 1422. Due to the shape of the trench 1304 and lateral projection 1424, the light shield 1300 is guided against the housing trim 1400 and rests comfortably thereon. The light shield 1300 defines a flume 1306 for receiving the foot 1420 of the housing trim 1400.

The light shield 1300 is screwed 1308 to the first housing portion 1100A as best shown in FIGS. 1A and 1B. Further, the housing cover 1200 is also screwed 1202 to the first housing portion 1100A and rests in the first linkage nexus 1418A of the housing trim 1400. Thus, the light shield 1300 and housing cover 1200 are statically positioned relative to the first housing portion 1100A, but can extend and retract relative to the second housing portion 1100B.

Indeed, the light shield 1300 can glide against the external surface 1408 of the housing trim 1400 with minimal friction. The ridge 1302 of the light shield 1300 rests on the curved nature of the intermediate junction 1414 of the housing trim 1400 and is capable of sliding thereon. The trench 1304 wraps around and receives the lateral projection 1424 of the elbow 1422 and is capable of sliding thereon. Further, the flume 1306 of the light shield 1300 receives the foot 1420 of the housing trim 1400 and is capable of sliding against the foot 1420.

Though, the opposite may be true in other embodiments, where the light shield 1300 and housing cover 1200 are statically positioned relative to the second housing portion 1100B, but can extend and retract relative to the first housing portion 1100A. Either configuration enables the first and second housing portions 1100A, 1100B to retract and extend relative to one another.

With the progression between FIGS. 1A and 1B, elongated optics positioned within the housing portions 1100A, 1100B shift internally via extension and retraction with the housing portions 1100A, 1100B, to enable the same or similar distributed light pattern between the Figures. The referenced optics and maneuverability will be discussed below.

Referring again to FIGS. 2 and 3, situated in the housing cavity 1108 and connected to the first housing portion 1100A is a first direct reflector 1500 made of extruded acrylic, polycarbonate, and/or aluminum. The first direct reflector 1500 has a first and second branch 1502A, 1502B diverging and extending outwardly, each congruently sized and shaped and configured for connection to the first housing portion 1100A. The branches 1502A, 1502B meet at a bridge 1504, located at the top of the first direct reflector 1500, thus forming a flared branch U-shape.

Detailed embodiments of the first direct reflector 1500 structure and connectivity to the housing are contemplated in U.S. patent application Ser. No. 18/416,185, entitled REFLECTOR AND REFLECTOR HOUSING FOR A LINEAR LIGHTING SYSTEM and filed on Jan. 18, 2024.

The bridge 1504 of the first direct reflector 1500 defines an additional screw boss 1506 for connection of constituent parts to the first direct reflector 1500. As shown in FIGS. 2 and 3, a mounting bracket 1600 is screwed to the first direct reflector 1500 via this screw boss 1506. The mounting bracket 1600 is defined by an upper and lower plate 1602, 1604 separated vertically by a hinge 1606, offsetting the two plates vertically and laterally. The upper plate 1602, when mounted, is generally aligned in orientation with the bridge 1504 of the first direct reflector 1500 into the page of FIG. 3, albeit not as long. When installed, the hinge 1606 abuts an extremity 1508 of the first direct reflector 1500, and the lower plate 1604 extends from the extremity 1508, thus enabling elongated lateral connection to an adjustable reflector 1700 as best shown in FIG. 2.

The adjustable reflector 1700 is formed of a similar material and has a similar shape and configuration as the first direct reflector 1500. For this reason, like reference numerals will be used to label the adjustable reflector 1700 as the first direct reflector 1500. The adjustable reflector 1700 deviates in configuration from the first direct reflector 1500 by the shape of the bridge 1704. The bridge 1704 of the adjustable reflector 1700 is rather planar as shown in FIG. 3, with a few screw holes 1750A, 1750B for attachment thereto, though lacking a screw boss.

While the upper plate 1602 of the mounting bracket 1600 is affixed to the bridge 1504 of the first direct reflector 1500, the lower plate 1604 affixes to the bridge 1704 of the adjustable reflector 1700. Due to the mounting bracket 1600 having an upper and lower plate 1602, 1604 separated vertically, the adjustable reflector 1700 is positioned vertically and laterally offset from first direct reflector 1500 upon assembly, such as along a vertical dimension 1104 shown in FIG. 3, and into the page of FIG. 3 respectively.

The mounting bracket 1600, and thus the adjustable reflector 1700, are static in movement relative to the first direct reflector 1500 in the embodiments shown, but it is envisioned that the pieces can be maneuverable along a rail (not distinctly shown). In such an embodiment, the adjustable reflector would be able to retract or extend relative to the first direct reflector. In the retracted position, the adjustable reflector and first direct reflector would vertically overlap, while in the extended position, the adjustable reflector and first direct reflector would laterally extend relative to one another.

Still referring to FIGS. 2 and 3, further situated in the housing cavity 1108 is a second direct reflector 1800, formed of a similar material and has a similar shape and configuration as the first 1500. For this reason, like reference numerals will be used to label the second direct reflector 1800 as the first direct reflector 1500. The second direct reflector 1800 is specifically connected to the second housing portion 1100B, and thus is adjusted in size to fit within the second housing portion 1100B. As with the first direct reflector 1500, detailed embodiments of the second direct reflector 1800 structure and connectivity to the housing are contemplated in U.S. patent application Ser. No. 18/416,185, entitled REFLECTOR AND REFLECTOR HOUSING FOR A LINEAR LIGHTING SYSTEM and filed on Jan. 18, 2024.

As mentioned prior, the adjustable reflector 1700 is positioned vertically below the first direct reflector 1500 upon assembly, such as along a vertical dimension 1104 shown in FIG. 3.

Further, upon assembly, the adjustable reflector 1700 is also positioned vertically below the second direct reflector 1800.

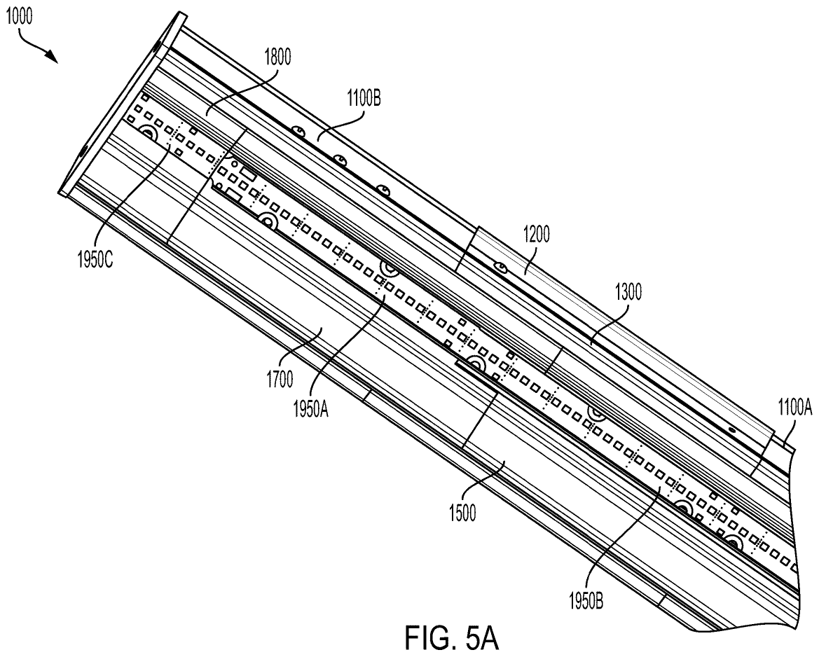

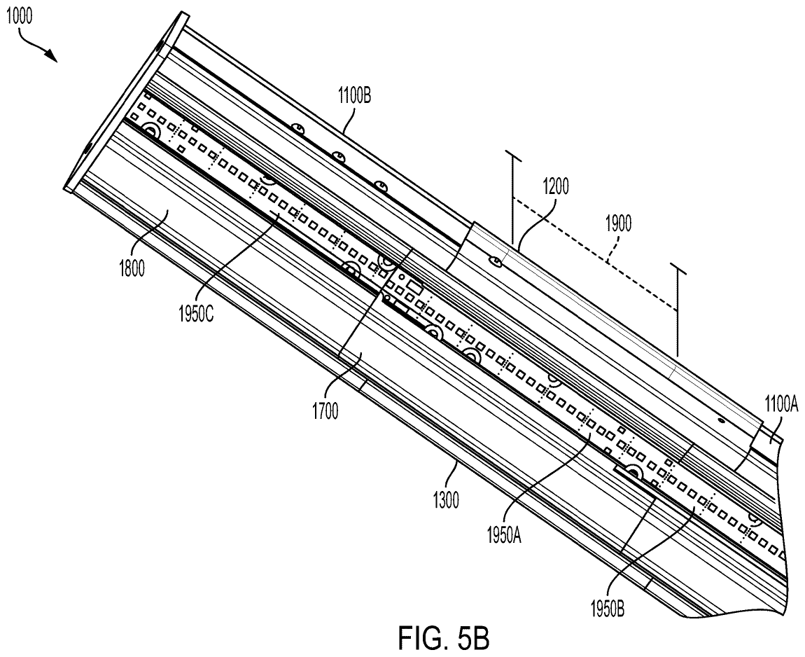

With this, FIG. 5A shows a retracted, subjacent view of the lighting system of FIG. 1A, while FIG. 5B shows an extended, subjacent view of the lighting system of FIG. 1B. In FIGS. 1A and 5A, the first and second housing portions 1100A, 1100B abut each other, forming a contiguous housing 1100. In a further respect, the first and second direct reflectors 1500, 1800, each separately positioned in their respective housing portion 1100A, 1100B, abut each other, forming a contiguous reflector. Because the mounting bracket 1600 affixed to the first direct reflector 1500 has an upper and lower plate 1602, 1604 separated vertically, the adjustable reflector 1700 is positioned vertically below the first direct reflector 1500 upon assembly, and thus slides beneath the second direct reflector 1800 as well.

When the first and second housing portions 1100A, 1100B are separated as shown in FIGS. 1B and 5B, the first and second direct reflectors 1500, 1800, are also separated from each other. Because the adjustable reflector 1700 is laterally offset as an extension of the first direct reflector 1500, and upon retraction slides beneath the second direct reflector 1800, the adjustable reflector 1700 upon extension, fills the adjustment gap 1900 of the lighting system 1000.

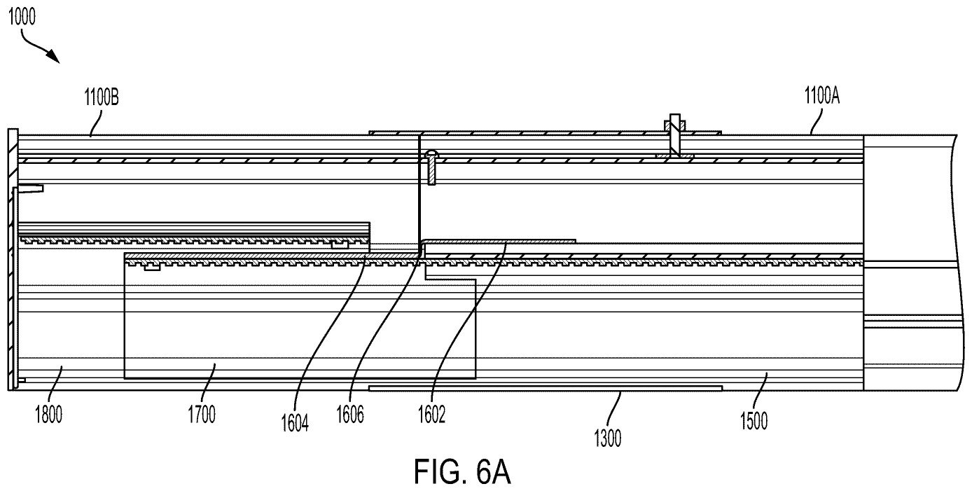

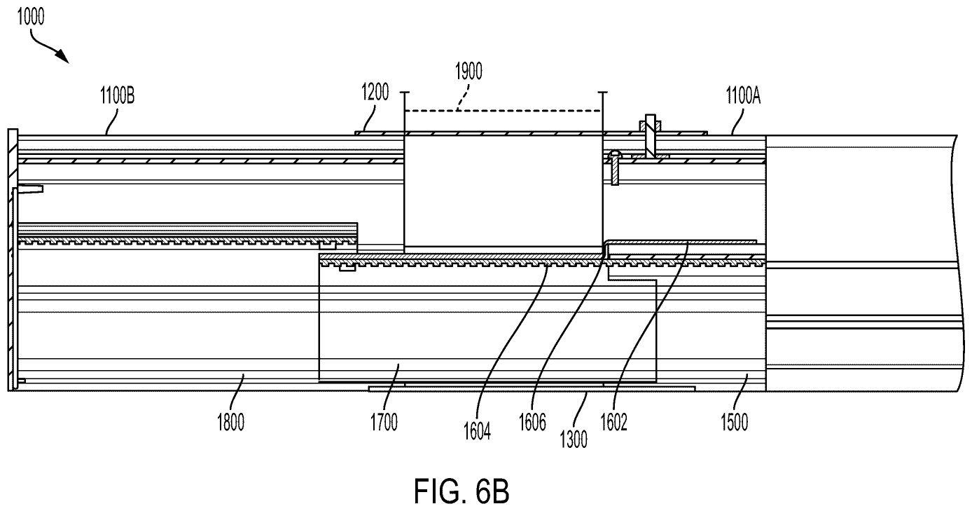

This is best shown in the progression between FIG. 6A and FIG. 6B. In FIG. 6A, the first and second housing portions 1100A, 1100B abut each other such as that shown in FIGS. 1A and 5A. The adjustable reflector 1700 is positioned vertically below the second direct reflector 1800 in a retracted, overlapped configuration. Turning to FIG. 6B, the adjustment gap 1900 of the lighting system 1000 forms as the lighting system 1000 is lengthened and the first and second housing portions 1100A, 1100B are separated. The adjustable reflector 1700 extends from underneath the second direct reflector 1800 to fill the adjustment gap 1900, thus enabling the entire length of the lighting system 1000 to house a reflector in both retracted and extended configurations.

With that, the adjustable reflector 1700 and the first and second direct reflectors 1500, 1800 are each designated an LED printed circuit board 1950A, 1950B, 1950C which slide into elongated slots 1760, 1560, 1860 formed by the branches 1702, 1502, 1802 and bridge 1704, 1504, 1804, that is, into and out of the page of FIG. 2. The reflectors 1700, 1500, 1800, serve to guide light expelled from their respective LED printed circuit boards 1950A, 1950B, 1950C to a lighting target, forming an optical cavity 1118.

Each LED printed circuit board 1950A, 1950B, 1950C is used to mount diodes and power LEDs to project into the optical cavity 1118 of the linear lighting system 1000. Because these LEDs and their operation generate a large amount of heat, the LED printed circuit boards 1950A, 1950B, 1950C may include a heat sink (not distinctly shown) or structural material that draws away heat. Hence, the LED printed circuit boards 1950A, 1950B, 1950C may be made of aluminum material, which excels at transferring heat away from the board and assisting in thermal management, or fiberglass. Over a base aluminum or fiberglass layer is a dielectric layer, topped by a copper circuit layer and a solder mask.

Further situated in the housing portions 1100A, 1100B is one or more electrical control system (not distinctly shown) to power the LED printed circuit boards 1950A, 1950B, 1950C. The electrical control system is a linear regulator or driver which may exist in a packaged integrated circuit. The control system requires a rectified voltage source, e.g., a bridge rectifier to rectify an alternating current voltage to generate a low voltage, direct current serving as a driving voltage of the lighting system 1000. Thus, the electrical control system is a current regulator, converting line voltage into a requisite printed circuit board voltage utilized by the LED printed circuit boards 1950A, 1950B, 1950C situated in the housing cavity 1108. The electrical control system connects to the LED printed circuit boards 1950A, 1950B, 1950C via contact leads (not distinctly shown).

To assemble the linear lighting system 1000, and referring back to FIGS. 2 and 3, the upper plate 1602 of the mounting bracket 1600 is first affixed to the first direct reflector 1500 via the screw boss 1506 on the reflector bridge 1504. Thereafter, the lower plate 1604 of the mounting bracket 1600 is affixed to the adjustable reflector 1700 via the screw holes 1750A, 1750B on the reflector bridge 1704. In sequence, the first direct reflector 1500 is snapped into the first housing portion 1100A and the second direct reflector 1800 is snapped into the second housing portion 1100B such as the method described in U.S. patent application Ser. No. 18/416,185, entitled REFLECTOR AND REFLECTOR HOUSING FOR A LINEAR LIGHTING SYSTEM and filed on Jan. 18, 2024.

Next, the housing trims 1400 are screwed to each side of the first and second housing portions 1100A, 1100B sandwiching the linking claw 1402 of the trim 1400 against the inward alcove 1114 of the housing 1100, ensuring that the intermediate rib 1404 of the trim 1400 is also pressured into the trim inlet 1116. Further, the housing cover 1200 is aligned in length with the light shield 1300 and screwed to the first housing portion 1100A via the sidewalls 1110, resting in the first linkage nexus 1418A of the housing trims 1400. The housing cover 1200 is also bolted 1202 to the intersecting crossbar 1112 of the housing, through a cable gripper plate 1975.

The light shield 1300 is then fed into the aforementioned sliding configuration against the housing trim 1400 of the second housing portion 1100B, such that the ridge 1302 of the light shield 1300 rests on the curved nature of the intermediate junction 1414 of the housing trim 1400. The trench 1304 wraps around and receives the lateral projection 1424 of the elbow 1422 of the second housing portion 1100B, and further, the flume 1306 of the light shield 1300 receives the foot 1420 of the housing trim 1400 of the second housing portion 1100B. Due to this loose interconnection, the light shield 1300 can slide relative to the second housing portion 1100B, with the housing cover 1200 gliding over the crossbar 1112 of the second housing portion 1100B.

In operation, a user can adjust the length of the lighting system 1000 simply by applying a tensile force to separate or retract the first and second housing portions 1100A, 1100B. The reflector 1700 adjusts appropriately internally to fill the adjustment gap 1900. The aforementioned configuration advantageously does not require the reconstruction of the housing 1000. When powered, the LEDs emit light uniformly, and without break, along the length of the lighting system 1000, providing illumination and efficiently converting electrical energy into light, offering versatile, energy-efficient solutions for various applications such as architectural, accent, or task lighting.

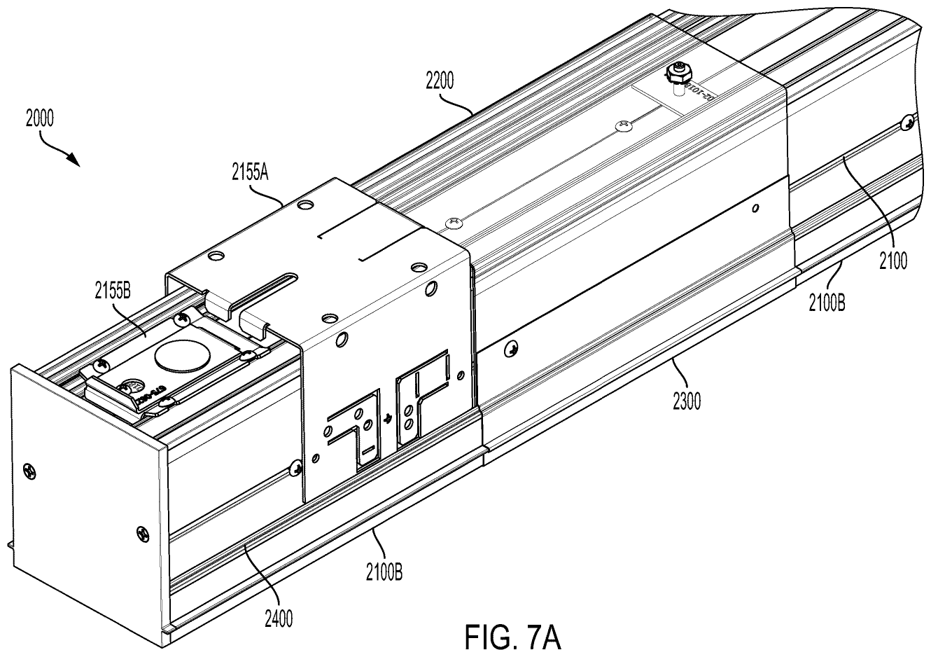

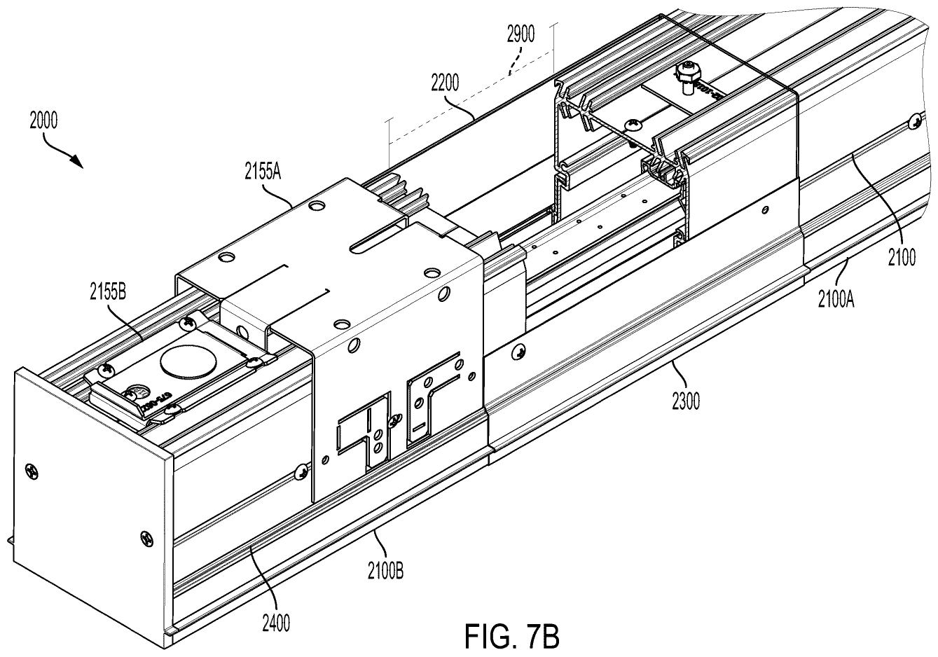

Referring now to FIGS. 7A through 13B, a second embodiment of the adjustable linear lighting system is shown and generally designated 2000. The lighting system 2000 shares certain structural and functional features with the first embodiment described above with respect to FIGS. 1 through 6B, and corresponding elements are designated by reference numerals in the two-thousand series. Like the first embodiment, the lighting system 2000 is configured to be selectively adjusted in length to accommodate varied installation environments, and may be set between a retracted configuration at minimum length and one or more extended configurations of greater length.

The lighting system 2000 comprises a housing 2100 formed by a first housing portion 2100A and a second housing portion 2100B. The housing portions 2100A, 2100B are longitudinally displaceable relative to one another: when in abutting relationship, the lighting system 2000 is in its retracted configuration at minimum configured length; when the first housing portion 2100A is drawn away from the second housing portion 2100B, an adjustment gap 2900 opens between the opposing ends of the two housing portions, placing the lighting system 2000 in an extended configuration whose length corresponds to the width of the adjustment gap 2900.

The second embodiment differs from the first principally in the construction of the length-adjustable illumination assembly and the manner in which optical continuity is maintained across the full configured length. Whereas the first embodiment employs a plurality of discrete, fixed-length LED boards within a housing that relies on a telescoping reflector assembly, the second embodiment provides a single expandable LED board 2700 that itself accommodates the full range of length adjustment. The board 2700 comprises a rigid portion 2702, permanently affixed within the second housing portion 2100B and fixed in position at all configured lengths, which spans the adjustment gap 2900 to bridge the two housing portions; and an expandable portion 2704, disposed within the first housing portion 2100A, which lengthens or shortens in response to relative movement between the rigid portion 2702 and the first housing portion 2100A. Within each housing portion, optical control is governed by the respective first and second direct reflectors 2500, 2800. In the adjustment gap 2900, the exposed region between the housing portions where no reflector housing is present, optical control is provided by optical control vanes 2650A, 2650B mounted to a bracket 2600 affixed to the second housing portion 2100B.

FIGS. 7A and 7B are isometric perspective views of the lighting system 2000. FIG. 7A shows the lighting system 2000 in the retracted configuration, with the first housing portion 2100A and the second housing portion 2100B in abutting relationship at the minimum configured length. FIG. 7B shows the lighting system 2000 in an extended configuration, with the first housing portion 2100A and the second housing portion 2100B longitudinally separated by the adjustment gap 2900, the width of which corresponds to the degree of extension selected. In both configurations, a housing cover 2200 extends over the superior surface of the housing 2100 to span the adjustment gap 2900 and present a continuous upper profile. A housing trim 2400 runs longitudinally along the inferior lateral edges of each housing portion. A light shield 2300, fixed to the first housing portion 2100A and guided along the housing trim 2400 of the second housing portion 2100B, closes the lower longitudinal opening through which illumination is emitted and spans the adjustment gap 2900 to maintain a continuous lower profile at any configured length.

The second housing portion 2100B, visible in both views, carries a first mounting adapter 2155A and a second mounting adapter 2155B. The mounting adapters 2155A, 2155B are configured to affix the lighting system 2000 to a ceiling, surface, pendant suspension, recessed opening, or other installation environment, as described in greater detail below.

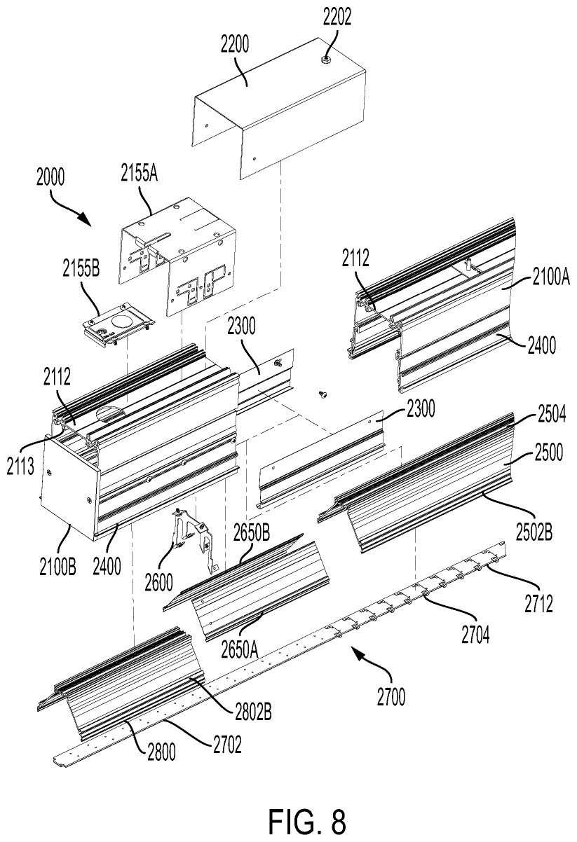

FIG. 8 is a fully exploded perspective view of the lighting system 2000, depicting both the first housing portion 2100A and the second housing portion 2100B with all components separated to illustrate the full component relationship of the assembly. Within the first housing portion 2100A, a first direct reflector 2500 is received. The first direct reflector 2500 defines a longitudinally extending slot 2560 that opens downwardly into the optical cavity 2118 and extends along substantially the full longitudinal length of the first direct reflector 2500. Within the second housing portion 2100B, a second direct reflector 2800 is received. The second direct reflector 2800 similarly defines a longitudinally extending slot 2860 that opens downwardly into the optical cavity 2118 and extends along substantially the full longitudinal length of the second direct reflector 2800. Each housing portion 2100A, 2100B further defines a crossbar 2112, a longitudinally extending structural rail along the superior extent of the housing portion about which the housing cover 2200 is engaged and retained. The crossbar 2112 of the second housing portion 2100B further defines one or more screw troughs 2113 extending longitudinally therealong and configured to receive fasteners for securing components to the second housing portion 2100B. The housing trim 2400 is received along the lower edges of each housing portion. The light shield 2300 is fixed to the first housing portion 2100A and configured to be guided along the housing trim 2400 of the second housing portion 2100B, closing the lower longitudinal opening and spanning the adjustment gap 2900 as the housing portions are displaced relative to one another.

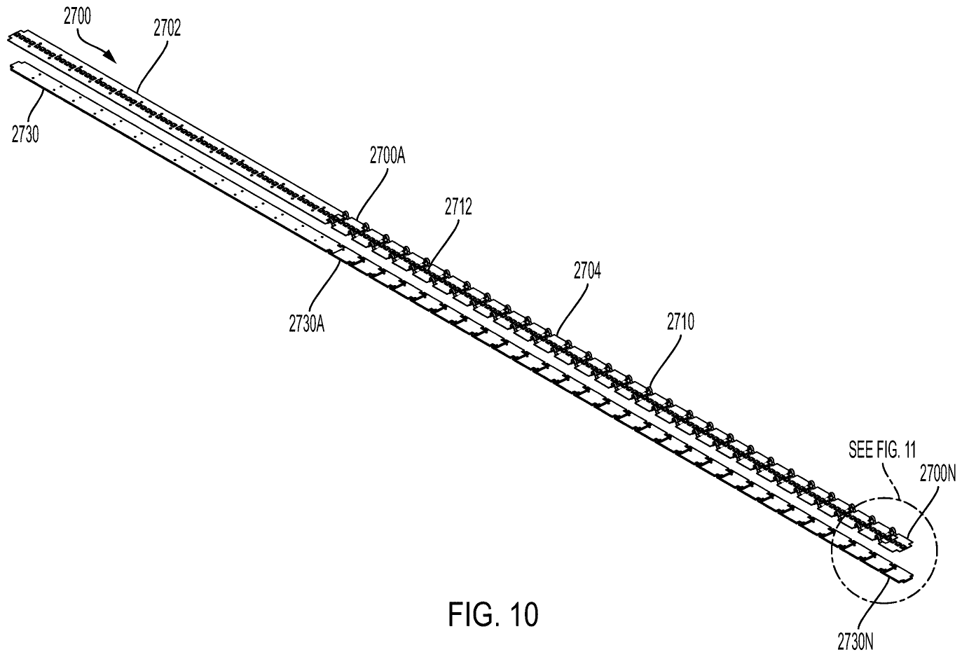

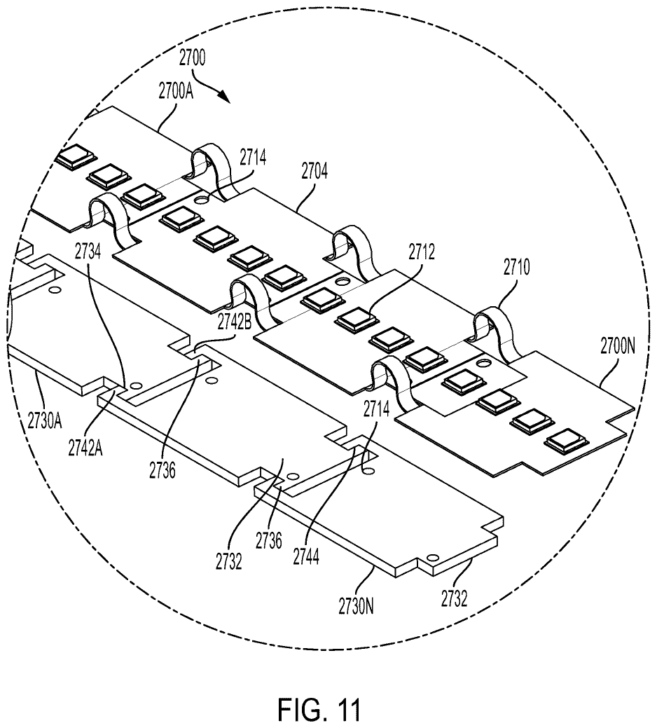

The expandable LED board 2700 comprises the rigid portion 2702 and the expandable portion 2704. The rigid portion 2702 is configured to be received within and secured to the slot 2860 of the second direct reflector 2800, fixing it in position within the second housing portion 2100B with LED packages 2712 oriented downwardly into the optical cavity 2118. The expandable portion 2704 is disposed within the first housing portion 2100A and received within the slot 2560 of the first direct reflector 2500. The expandable portion 2704 is configured to lengthen or shorten as the first housing portion 2100A moves relative to the rigid portion 2702, with intermediate plate segments being slidably guided within the slot 2560. The construction and internal component arrangement of the board 2700 are described in greater detail below with reference to FIGS. 10 and 11.

A bracket 2600 is secured to the second housing portion 2100B at its end facing the adjustment gap 2900 by fasteners received in the screw troughs 2113 of the crossbar 2112, rendering the bracket 2600 stationary relative to both the second direct reflector 2800 and the second housing portion 2100B. The bracket 2600 carries a first optical control vane 2650A and a second optical control vane 2650B, each mounted to and depending from the bracket 2600. The optical control vanes 2650A, 2650B project into the adjustment gap 2900, providing optical control of the lateral distribution of light and defining the emission angle in the exposed region between the first and second housing portions 2100A, 2100B where the rigid portion 2702 spans and no reflector housing is present above.

The first mounting adapter 2155A and second mounting adapter 2155B are both fastened to the second housing portion 2100B. The first mounting adapter 2155A is configured to wrap around and engage the exterior of the second housing portion 2100B, providing a surface-mount or ceiling-mount affixment interface. The second mounting adapter 2155B is configured to be received within a void or opening defined in the upper portion of the second housing portion 2100B, providing an alternative affixment interface for pendant suspension, recessed mounting, or other installation configurations. The mounting adapters 2155A, 2155B are interchangeable and complementary, allowing the lighting system 2000 to be adapted to a variety of installation environments without modification to the housing 2100 itself.

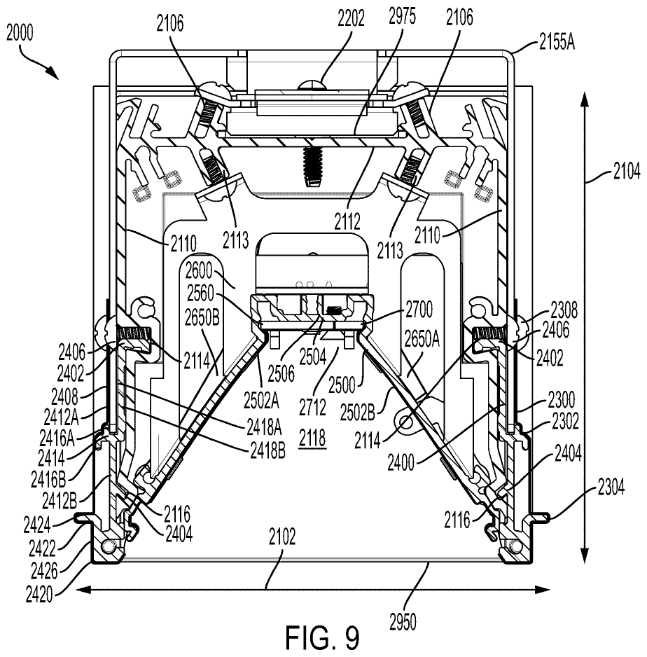

FIG. 9 is a cross-sectional view taken looking down the longitudinal axis of the fixture, with the cut plane passing partially through the second housing portion 2100B at the location of the first mounting adapter 2155A, wrapped about the exterior of the second housing portion 2100B. The cross-section reveals the internal geometry of the second housing portion 2100B, which is largely similar to the first embodiment of FIGS. 1-6B.

The second direct reflector 2800 is received within the second housing portion 2100B and cooperates with the second housing portion 2100B to define a portion of the optical cavity 2118, with the slot 2860 opening downwardly into the optical cavity 2118. The rigid portion 2702 of the expandable LED board 2700 is seated within the slot 2860, with the LED packages 2712 oriented downwardly into the optical cavity 2118. The bracket 2600 is secured to the screw troughs 2113 of the crossbar 2112 of the second housing portion 2100B, with the optical control vanes 2650A, 2650B depending from the bracket 2600 at respective lateral positions flanking the rigid portion 2702. The optical control vanes 2650A, 2650B are oriented to project into the adjustment gap 2900 to provide optical control of the light emitted downwardly from the LED packages 2712 of the rigid portion 2702 in the exposed region between the housing portions, where no reflector housing is present above.

In some embodiments, a lens 2950 is coupled to the housing trim 2400 and extends along the lower opening of the lighting system 2000. The lens 2950 may be formed from a transparent, translucent, diffusive, prismatic, or otherwise optically transmissive material selected to provide a desired output distribution, glare control, diffusion, or visual appearance. The housing trim 2400 may include a foot 2420 positioned along a lower edge of the housing 2100, and the lens 2950 may be configured to snap into engagement with the foot 2420 of the housing trim 2400. For example, the lens 2950 may include one or more resilient edge portions, lips, channels, or retention features that engage the foot 2420 to retain the lens 2950 relative to the housing trim 2400 while permitting installation or removal of the lens 2950 without disassembly of the housing portions 2100A, 2100B. When installed, the lens 2950 may close or cover at least part of the lower opening of the optical cavity 2118 and may transmit light emitted from the LED packages 2712 toward an illumination target.

FIGS. 10 and 11 show the expandable LED board 2700 and its constituent components in greater detail. FIG. 10 shows the board 2700 in an assembled configuration with both a rigid portion 2702 and expandable portion 2704. FIG. 11 shows solely the expandable portion 2704 of the board 2700 in an enlarged detail view, illustrating the relationship of its components. The rigid portion 2702 is fixed relative to the second housing portion 2100B in all configurations of the lighting system 2000, being permanently secured within the slot 2860 of the second direct reflector 2800. The rigid portion 2702 extends longitudinally from the second housing portion 2100B toward the first housing portion 2100A and is slidably received within the slot 2560 of the first direct reflector 2500 during adjustment of the lighting system 2000. As the first housing portion 2100A moves relative to the second housing portion 2100B, the first direct reflector 2500 moves longitudinally relative to the rigid portion 2702 while the rigid portion 2702 remains fixed relative to the second housing portion 2100B. The rigid portion 2702 has a length sufficient to span the adjustment gap 2900 and remain received within the slot 2560 of the first direct reflector 2500 at all configured lengths of the lighting system 2000, including at a maximum extension of the adjustment gap 2900. Once the lighting system 2000 is positioned at a selected configured length, the rigid portion 2702 may be additionally secured within the slot 2560 of the first direct reflector 2500 to fix the first and second housing portions 2100A, 2100B at the selected configured length. The expandable portion 2704 is disposed within the first housing portion 2100A and extends between the rigid portion 2702 and the first housing portion 2100A such that movement of the first housing portion 2100A relative to the rigid portion 2702 causes the expandable portion 2704 to lengthen or shorten.

The expandable portion 2704 comprises a plurality of board segments 2700A-2700N arranged in longitudinal series within the first housing portion 2100A. Each board segment 2700A-2700N is a discrete printed circuit board section carrying one or more LED packages 2712 on its downward-facing surface, such that in the installed configuration the LED packages 2712 emit light downwardly into the optical cavity 2118. Adjacent board segments 2700A-2700N are electrically interconnected by conductive ribbons 2710. Each conductive ribbon 2710 is a flexible electrical conductor that spans between and is connected at each of its ends to neighboring board segments, providing electrical continuity along the full series of board segments 2700A-2700N. The conductive ribbons 2710 are of sufficient length to accommodate the maximum relative longitudinal displacement between adjacent board segments as the expandable portion 2704 reaches its fully extended configuration, while remaining compact enough to fold or drape without interference when the expandable portion 2704 is in the retracted configuration. The board segments 2700A-2700N are connectable at one end of the series, or through the conductive ribbons 2710, to a driver and electrical source, not shown, to supply regulated current to the LED packages 2712 in all configured lengths of the lighting system 2000.

Each board segment 2700A-2700N is individually secured to a corresponding plate segment 2730A-2730N by one or more fasteners 2738 received through mounting apertures 2714 defined through each board segment, joining each board-segment-and-plate-segment pair in a face-to-face stacked relationship with the LED packages 2712 facing downwardly away from the plate segment. The plate segments 2730A-2730N form a longitudinally expandable and retractable structural backbone underlying the board segments 2700A-2700N, and it is the interlocking geometry of the plate segments 2730A-2730N that governs the extension, retraction, and retention of the expandable portion 2704. Each plate segment 2730A-2730N defines a planar body portion. At a first longitudinal end of the body portion, a laterally reduced extension tongue 2732 projects longitudinally therefrom, with a retaining shoulder 2736 formed thereon. At the opposing second longitudinal end, a first arm 2742A and a second arm 2742B extend longitudinally from the body portion on the side opposite the extension tongue 2732, spaced laterally apart to define a receiving channel 2734 therebetween. The inward-facing surfaces of the first and second arms 2742A, 2742B define stop surfaces 2744 that face into the receiving channel 2734. The receiving channel 2734 is sized to slidably receive the extension tongue 2732 of an adjacent plate segment, with the retaining shoulder 2736 having a lateral dimension that exceeds the clear width of the receiving channel 2734 at the stop surfaces 2744. When adjacent plate segments 2730A-2730N are drawn apart, the retaining shoulder 2736 of the received extension tongue 2732 bears against the stop surfaces 2744 of the first and second arms 2742A. 2742B, arresting further separation and retaining adjacent plate segments in interlocked engagement without disassembly. In the retracted configuration, the plate segments 2730A-2730N are in a collapsed arrangement within the first housing portion 2100A, with the extension tongues 2732 fully seated within the receiving channels 2734, between the first and second arms 2742A, 2742B, and adjacent plate segments in contact or close proximity; the board segments 2700A-2700N, being fastened to the plate segments, are carried into the same collapsed arrangement. As the first housing portion 2100A is separated from the second housing portion 2100B, the plate segments 2730A-2730N spread apart within the first housing portion 2100A, with the extension tongues 2732 sliding outwardly within the receiving channels 2734 until the retaining shoulders 2736 bear against the stop surfaces 2744 of the first and second arms 2742A, 2742B at the fully extended configuration, carrying the stacked board segments 2700A-2700N with them.

The expandable LED board 2700 may be fixed relative to the lighting system 2000 at two longitudinally spaced anchoring locations. A first anchoring location may be defined where the rigid portion 2702 is secured relative to the second housing portion 2100B, such as by securement of the rigid portion 2702 within the slot 2860 of the second direct reflector 2800. A second anchoring location may be defined where an end of the expandable portion 2704 opposite the rigid portion 2702 is secured relative to the first housing portion 2100A, such as by securement of one of the plate segments 2730A-2730N within the slot 2560 of the first direct reflector 2500. The plate segments disposed between the first and second anchoring locations are slidably received within the slot 2560. Accordingly, as the first housing portion 2100A moves relative to the second housing portion 2100B, the distance between the first and second anchoring locations changes, causing the intermediate plate segments to spread apart or collapse while the rigid portion 2702 remains fixed relative to the second housing portion 2100B.

The slots 2560, 2860 of the first and second direct reflectors 2500, 2800 receive the board 2700 and orient the LED packages 2712 downwardly into the optical cavity 2118. Each of the slots 2560, 2860 may extend along substantially the full longitudinal length of its respective direct reflector 2500, 2800. The slot 2860 of the second direct reflector 2800 receives and supports the rigid portion 2702 at the first anchoring location, where the rigid portion 2702 is fixed relative to the second housing portion 2100B. The slot 2560 of the first direct reflector 2500 receives the expandable portion 2704 and also slidably receives part of the rigid portion 2702 so that the first direct reflector 2500 may move relative to the rigid portion 2702 during adjustment. In some embodiments, a gap-facing region of the slot 2560 slidably receives the rigid portion 2702, and a longitudinally spaced region of the slot 2560 receives the expandable portion 2704, such that the rigid portion 2702 and the expandable portion 2704 are received in different longitudinal regions of the same slot 2560. The slot 2560 has a longitudinal length sufficient to accommodate both the rigid portion 2702 received therein and the expandable portion 2704 throughout the full range of adjustment without preventing expansion or collapse of the expandable portion 2704.

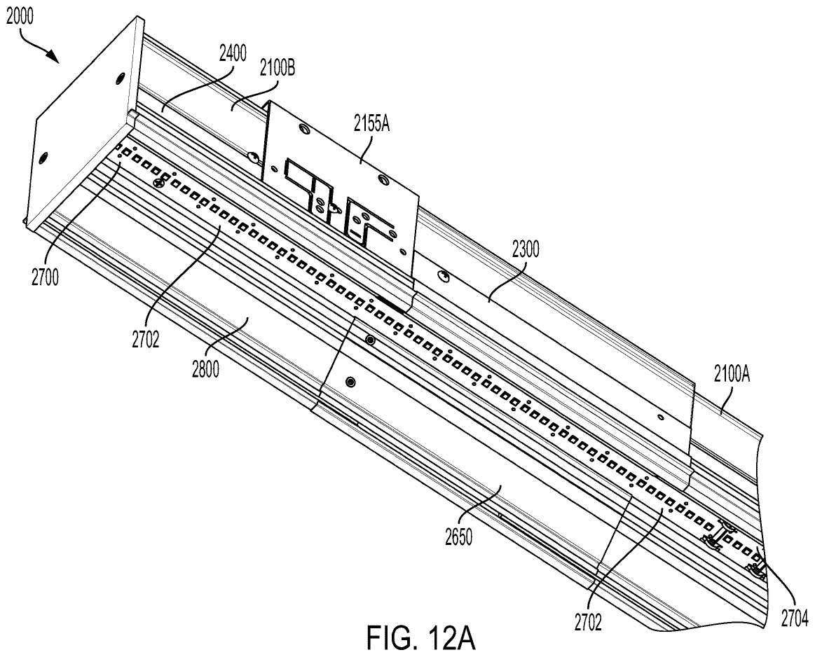

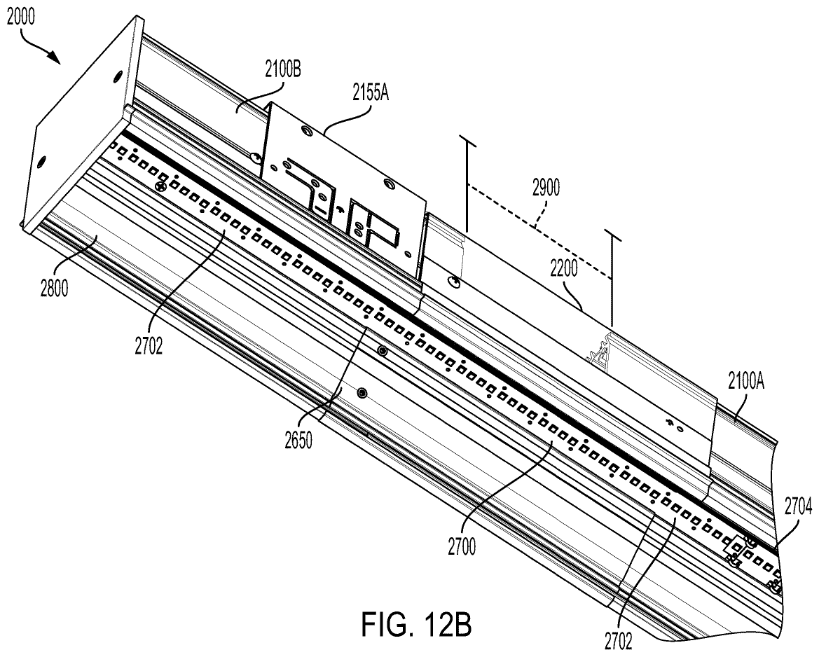

FIGS. 12A and 12B are subjacent perspective views of the assembled lighting system 2000 looking upwardly toward the housing 2100, with FIG. 12A in the retracted configuration and FIG. 12B in an extended configuration. In both views, the expandable LED board 2700 is visible along the underside of the housing 2100, with the LED packages 2712 oriented downwardly within the optical cavity 2118 to emit light toward the illumination target.

In FIG. 12A, the first housing portion 2100A and the second housing portion 2100B are in abutting relationship with no adjustment gap 2900 therebetween. The plate segments 2730A-2730N of the expandable portion 2704 are in their fully collapsed arrangement within the first housing portion 2100A, with the board segments 2700A-2700N carried into the same collapsed arrangement. The rigid portion 2702 extends from its fixed position in the slot 2860 of the second direct reflector 2800 into the slot 2560 of the first direct reflector 2500, bridging the interface between the two housing portions. The LED packages 2712 of both the rigid portion 2702 and the collapsed expandable portion 2704 face downwardly in a continuous array along the full combined length of the lighting system 2000. In the retracted configuration, with no adjustment gap 2900 present, the optical control vanes 2650A, 2650B, being stationary relative to the second housing portion 2100B, are disposed adjacent the first direct reflector 2500 of the first housing portion 2100A.

With the housing extended as shown in FIG. 12B, the first housing portion 2100A has been drawn away from the second housing portion 2100B to form the adjustment gap 2900. The rigid portion 2702 remains stationary relative to the second housing portion 2100B, spanning the adjustment gap 2900 and continuing to be received within the slot 2560 of the first direct reflector 2500. Within the first housing portion 2100A, the plate segments 2730A-2730N of the expandable portion 2704 have spread apart in response to relative movement between the rigid portion 2702 and the first housing portion 2100A. In particular, one end of the expandable portion 2704 is held relative to the rigid portion 2702, while an opposing end of the expandable portion 2704 is held relative to the first housing portion 2100A or the first direct reflector 2500. As the distance between those ends increases, the extension tongues 2732 are drawn outwardly within the receiving channels 2734, with the retaining shoulders 2736 bearing against the stop surfaces 2744 of the first and second arms 2742A, 2742B, carrying the board segments 2700A-2700N with them. The conductive ribbons 2710 span between adjacent board segments, maintaining electrical continuity throughout the extended expandable portion 2704. The LED packages 2712 remain continuously oriented downwardly along the full adjusted length of the lighting system 2000. The optical control vanes 2650A, 2650B, carried by the bracket 2600 on the second housing portion 2100B, project into the adjustment gap 2900 to provide optical control of the light emitted downwardly from the LED packages 2712 of the rigid portion 2702 in the exposed region between the housing portions.

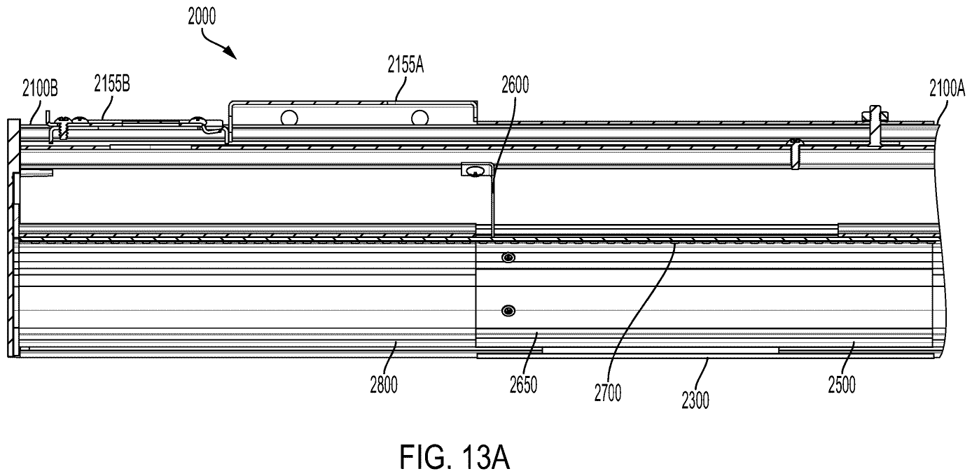

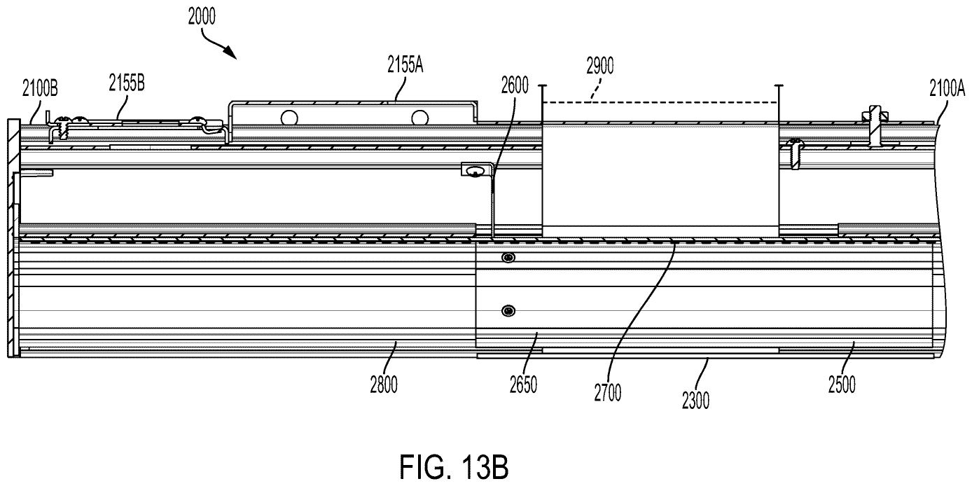

FIGS. 13A and 13B are transverse cross-sectional views of the lighting system 2000, with FIG. 13A showing the lighting system 2000 in the retracted configuration and FIG. 13B showing the lighting system 2000 in an extended configuration. Together they illustrate how the board 2700, the direct reflectors 2500, 2800, and the optical control vanes 2650A, 2650B relate to one another across two configurations.

In the retracted configuration of FIG. 13A, the first housing portion 2100A and the second housing portion 2100B are in abutting relationship with no adjustment gap 2900 therebetween.

The first and second direct reflectors 2500, 2800 cooperate with the housing portions 2100A, 2100B to define the optical cavity 2118, with slots 2560, 2860 opening downwardly into the optical cavity 2118. The expandable portion 2704 is in its collapsed arrangement within the first housing portion 2100A, with the plate segments 2730A-2730N and stacked board segments 2700A-2700N in contact or close proximity within the slot 2560. The rigid portion 2702 is received within the slot 2860 of the second direct reflector 2800 and extends into the slot 2560 of the first direct reflector 2500, bridging the interface between the two abutting housing portions with LED packages 2712 facing downwardly throughout. The optical control vanes 2650A, 2650B, carried by the bracket 2600 on the second housing portion 2100B, are disposed adjacent the first direct reflector 2500 in the retracted configuration. The housing cover 2200 is engaged about the crossbar 2112 of each housing portion. The housing trim 2400 is received along the lower edges of each housing portion, and the light shield 2300, fixed to the first housing portion 2100A and guided along the housing trim 2400 of the second housing portion 2100B, closes the lower longitudinal opening.

FIG. 13B shows the lighting system 2000 in an extended configuration, with the adjustment gap 2900 open between the first housing portion 2100A and the second housing portion 2100B. The rigid portion 2702 spans the adjustment gap 2900, fixed within the slot 2860 of the second direct reflector 2800 and received within the slot 2560 of the first direct reflector 2500, with LED packages 2712 facing downwardly throughout the span. Within the first housing portion 2100A, the plate segments 2730A-2730N of the expandable portion 2704 are spread apart within the slot 2560 in response to movement of the first housing portion 2100A relative to the rigid portion 2702. The slot 2560 slidably guides intermediate plate segments while an end of the expandable portion 2704 opposite the rigid portion 2702 is fixed relative to the first housing portion 2100A or the first direct reflector 2500. The extension tongues 2732 are drawn outwardly within the receiving channels 2734, with the retaining shoulders 2736 bearing against the stop surfaces 2744 of the first and second arms 2742A, 2742B, carrying the board segments 2700A-2700N with them. The optical control vanes 2650A, 2650B, secured to the bracket 2600 via the screw troughs 2113 of the crossbar 2112 and stationary relative to the second housing portion 2100B, project into the adjustment gap 2900 to provide optical control in the exposed region between the housing portions. The optical cavity 2118 remains governed within the housing portions 2100A, 2100B by the respective direct reflectors 2500, 2800, and within the adjustment gap 2900 by the optical control vanes 2650A, 2650B. The first mounting adapter 2155A is visible at the exterior of the second housing portion 2100B, shown wrapped about the exterior thereof.

In assembling the lighting system 2000, the expandable portion 2704 of the board 2700 is first constructed by individually fastening each board segment 2700A-2700N to its corresponding plate segment 2730A-2730N via one or more fasteners 2738 through the mounting apertures 2714, placing each board-segment-and-plate-segment pair in face-to-face stacked relationship with the LED packages 2712 facing downwardly. To adapt to the size of the rigid portion 2702 of the board 2700, a corresponding plate segment 2730A-2730N may be dimensioned larger, or may retain the same size as those plate segments conforming with the expandable portion 2704 of the board 2700.

The plate segments 2730A-2730N are then interlinked in series by inserting the extension tongue 2732 of each plate segment into the receiving channel 2734 of the adjacent plate segment, between the first and second arms 2742A, 2742B thereof, until the retaining shoulders 2736 engage the stop surfaces 2744 of the arms 2742A, 2742B to retain the assembly. The conductive ribbons 2710 are connected between adjacent board segments 2700A-2700N to complete the electrical series interconnection of the expandable portion 2704, and the board segments are connected at one end of the series, or through the ribbons 2710, to a driver and electrical source, not shown.

The first direct reflector 2500 is installed within the first housing portion 2100A, and the assembled expandable portion 2704 is received within the slot 2560 with the LED packages 2712 oriented downwardly into the optical cavity 2118. An end of the expandable portion 2704 opposite the rigid portion 2702 is secured relative to the first housing portion 2100A or the first direct reflector 2500, while intermediate plate segments of the expandable portion 2704 remain slidable within the slot 2560. The second direct reflector 2800 is installed within the second housing portion 2100B, and the rigid portion 2702 of the board 2700 is received within and secured to the slot 2860, affixing the rigid portion 2702 in a fixed position within the second housing portion 2100B. The rigid portion 2702 extends from the second housing portion 2100B into the slot 2560 of the first direct reflector 2500, where the rigid portion 2702 is slidably received during adjustment so that the first housing portion 2100A may move relative to the rigid portion 2702 while the rigid portion 2702 continues to span the adjustment gap 2900. Once the lighting system 2000 is set to a desired length, the rigid portion 2702 may be additionally secured within the slot 2560 to fix the two housing portions at the selected configured length.

The bracket 2600 is secured to the screw troughs 2113 of the crossbar 2112 of the second housing portion 2100B, rendering the bracket 2600 and optical control vanes 2650A, 2650B stationary relative to the second direct reflector 2800 and the second housing portion 2100B. The mounting adapters 2155A, 2155B are secured to the second housing portion 2100B in the configuration appropriate for the installation environment. The housing cover 2200 is engaged about the crossbar 2112 of each housing portion. The housing trim 2400 is secured along the lower edges of each housing portion, and the light shield 2300 is fixed to the first housing portion 2100A and fed into sliding engagement with the housing trim 2400 of the second housing portion 2100B, closing the lower longitudinal opening and completing the exterior profile of the lighting system 2000.

In operation, the overall length of the lighting system 2000 is adjusted by longitudinally displacing the first housing portion 2100A relative to the second housing portion 2100B. As the first housing portion 2100A is drawn away from the second housing portion 2100B, the adjustment gap 2900 opens between the opposing ends of the two housing portions. The rigid portion 2702, being fixed to the second housing portion 2100B through the second direct reflector 2800, remains stationary relative to the second housing portion 2100B. The first direct reflector 2500 slides longitudinally relative to the rigid portion 2702 while the rigid portion 2702 remains received within the slot 2560. Because the rigid portion 2702 has a length sufficient to span the maximum permitted width of the adjustment gap 2900 while remaining received within the slot 2560, the rigid portion 2702 continues to span the adjustment gap 2900 throughout adjustment. The optical control vanes 2650A, 2650B, being stationary relative to the second housing portion 2100B, project into the adjustment gap 2900 at all extended lengths to provide optical control of the light emitted downwardly from the LED packages 2712 of the rigid portion 2702 in the exposed region between the housing portions.

Concurrently, within the first housing portion 2100A, the opposing ends of the expandable portion 2704 move relative to one another because one end of the expandable portion 2704 is held relative to the rigid portion 2702 and the opposing end of the expandable portion 2704 is held relative to the first housing portion 2100A or the first direct reflector 2500. This relative movement causes the plate segments 2730A-2730N of the expandable portion 2704 to spread apart, with the extension tongues 2732 sliding outwardly within the receiving channels 2734 until the retaining shoulders 2736 bear against the stop surfaces 2744 of the first and second arms 2742A, 2742B at the fully extended position, carrying the board segments 2700A-2700N with them. The conductive ribbons 2710 spanning between adjacent board segments accommodate the increasing inter-segment spacing and maintain electrical continuity throughout. Once the desired length is reached, the rigid portion 2702 may be secured within the slot 2560 to lock the configured length. Retraction is accomplished by returning the first housing portion 2100A toward the second housing portion 2100B: the adjustment gap 2900 closes, the plate segments 2730A-2730N compact within the first housing portion 2100A, the extension tongues 2732 reseating within the receiving channels 2734 between the first and second arms 2742A, 2742B, and the board segments 2700A-2700N return to their collapsed arrangement. As the first housing portion 2100A returns to abutment with the second housing portion 2100B, the optical control vanes 2650A, 2650B are disposed adjacent the first direct reflector 2500 of the first housing portion 2100A. At any configured length, the LED packages 2712 across the full extent of the board 2700 remain oriented downwardly and are continuously energized to provide uniform illumination along the full length of the lighting system 2000.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment.

While the subject technology has been described with respect to various embodiments, those skilled in the art will readily appreciate that various changes and/or modifications can be made to the subject technology without departing from the scope of the present disclosure.

What is claimed is:

1. A lighting system comprising:
a housing having a first housing portion and a second housing portion configured for relative movement with respect to one another along a longitudinal axis of the lighting system, the first housing portion and the second housing portion being configured to define an adjustment gap therebetween in an extended configuration;
a first direct reflector positioned within the first housing portion;
a second direct reflector positioned within the second housing portion, wherein at least the first housing portion, the second housing portion, the first direct reflector, and the second direct reflector collectively define an optical cavity extending along the lighting system; and
an expandable LED board comprising a rigid portion and an expandable portion, the rigid portion being fixed relative to the second housing portion and configured to span the adjustment gap, the expandable portion being disposed within the first housing portion and extending between the rigid portion and the first housing portion such that displacement of the first housing portion relative to the rigid portion causes the expandable portion to lengthen or shorten.

2. The lighting system of claim 1, wherein the first housing portion and the second housing portion are in abutting relationship in a retracted configuration at a minimum configured length, and wherein the first housing portion is drawn away from the second housing portion in the extended configuration such that the adjustment gap opens between opposing ends of the first and second housing portions.

3. The lighting system of claim 1, wherein the rigid portion of the expandable LED board is permanently secured within a slot of the second direct reflector and is slidably received within a slot of the first direct reflector during movement of the first housing portion relative to the second housing portion.

4. The lighting system of claim 3, wherein the rigid portion is additionally securable within the slot of the first direct reflector after movement of the first housing portion relative to the second housing portion to fix the first and second housing portions at a selected configured length.

5. The lighting system of claim 1, further comprising a bracket secured to the second housing portion and optical control vanes carried by the bracket, the optical control vanes projecting into the adjustment gap to provide optical control of light emitted downwardly from LED packages of the rigid portion in an exposed region between the first and second housing portions, wherein the optical control vanes further define the optical cavity within the adjustment gap.

6. A lighting system comprising:
a first housing portion and a second housing portion configured to move relative to one another between a retracted configuration and an extended configuration;
an expandable LED board comprising a rigid portion fixed in position relative to the second housing portion and an expandable portion disposed within the first housing portion, the expandable portion comprising a plurality of board segments arranged in longitudinal series within the first housing portion;
a plurality of LED packages disposed on downward-facing surfaces of the plurality of board segments;
a plurality of conductive ribbons electrically interconnecting adjacent board segments of the plurality of board segments; and
a plurality of plate segments respectively secured to the plurality of board segments, the plurality of plate segments being configured to spread apart and collapse within the first housing portion as the first housing portion moves relative to the rigid portion.

7. The lighting system of claim 6, wherein each board segment is individually secured to a corresponding plate segment by one or more fasteners received through mounting apertures defined through the board segment, thereby joining each board-segment-and-plate-segment pair in a face-to-face stacked relationship with the LED packages facing downwardly away from the corresponding plate segment.

8. The lighting system of claim 6, wherein each plate segment defines a planar body portion, an extension tongue projecting longitudinally from a first longitudinal end of the planar body portion, and first and second arms extending longitudinally from an opposing second longitudinal end of the planar body portion.

9. The lighting system of claim 8, wherein the first and second arms are spaced laterally apart to define a receiving channel therebetween sized to slidably receive the extension tongue of an adjacent plate segment.

10. The lighting system of claim 9, wherein the extension tongue includes a retaining shoulder, and wherein inward-facing surfaces of the first and second arms define stop surfaces configured to engage the retaining shoulder to arrest further separation between adjacent plate segments and retain the adjacent plate segments in interlocked engagement without disassembly.

11. The lighting system of claim 6, wherein a first end of the expandable portion is held relative to the rigid portion and an opposing second end of the expandable portion is held relative to the first housing portion or a first direct reflector positioned within the first housing portion.

12. A lighting system comprising:
a first housing portion and a second housing portion configured for relative longitudinal displacement between a retracted configuration and an extended configuration;
a first direct reflector positioned within the first housing portion and defining a first slot opening downwardly into an optical cavity;
a second direct reflector positioned within the second housing portion and defining a second slot opening downwardly into the optical cavity; and
an expandable LED board comprising a rigid portion and an expandable portion, the rigid portion being received within and secured to the second slot of the second direct reflector and extending from the second housing portion toward the first housing portion, the rigid portion being slidably received within the first slot of the first direct reflector during relative longitudinal displacement between the first and second housing portions, the expandable portion being received within the first slot of the first direct reflector and comprising plate segments that are longitudinally expandable and retractable within the first housing portion.

13. The lighting system of claim 12, wherein the rigid portion spans an adjustment gap formed between the first and second housing portions in the extended configuration and remains received within the first slot of the first direct reflector throughout relative longitudinal displacement between the first and second housing portions.

14. The lighting system of claim 12, wherein the first and second slots are dimensioned to receive a combined plate-segment-and-board-segment stack as a unit, with LED packages oriented to face downwardly out of the first and second slots and into the optical cavity.

15. The lighting system of claim 12, wherein the first slot extends along substantially a full longitudinal length of the first direct reflector, and wherein, during adjustment of the lighting system, a gap-facing region of the first slot slidably receives the rigid portion and a longitudinally spaced region of the first slot receives the expandable portion.

16. The lighting system of claim 12, wherein each plate segment includes an extension tongue slidably received within a receiving channel of an adjacent plate segment, and wherein the plate segments are configured to spread apart within the first housing portion as the first housing portion is separated from the second housing portion.

17. The lighting system of claim 16, wherein each extension tongue includes a retaining shoulder configured to bear against stop surfaces of first and second arms of an adjacent plate segment at a fully extended configuration, thereby limiting further longitudinal separation between adjacent plate segments.
